(19) United States
(12) Patent Application Publication
(10) Pub. No.: US 2025/0220068 A1
(43) Pub. Date: Jul. 3, 2025

(54) DEVICE CONNECT AND SHARE MANAGEMENT

(71) Applicant: Google LLC, Mountain View, CA (US)

(72) Inventors: Yash Dave, Sunnyvale, CA (US); Ryan Ausanka-Crues, Santa Barbara, CA (US)

(21) Appl. No.: 18/399,325

(22) Filed: Dec. 28, 2023

(51) Int. Cl. H04L 67/06; H04L 67/2871

(52) U.S. Cl. CPC H04L 67/06; H04L 67/2871

(57) ABSTRACT

A first computing device, logged into a user account, efficiently shares application data with one or more second computing devices under the same account. The first device optimizes connections to the second devices based on connectivity heuristics and contextual factors. Companion applications on both devices facilitate seamless communication and data sharing. After connection, companion applications exchange metadata for authorization confirmation, ensuring the second devices and their applications are approved to receive shared data. Once authorized, the first device securely transmits application data through companion applications, which then seamlessly integrate the received data into their respective authorized applications.

### BACKGROUND

Developers who allow their applications to share application data with applications executing on other computing devices face the challenge of determining the communication protocols and pathways that will efficiently transmitting data to various user devices. Additionally, developers must then determine how to establish the necessary connections. The technical complexities involved in these processes present a significant obstacle for many developers who do not wish to navigate this series of challenges simply to share application data.

### SUMMARY

In general, various aspects of the techniques described in this disclosure are directed to a first computing device signed into a user account that is able to share application data with one or more second computing devices that are also signed into the same user account. The first computing device may determine the method of connecting to the one or more second computing devices based on a plurality of connectivity heuristics and various contextual factors. Companion applications installed on the respective computing devices may facilitate communications and data sharing between computing devices. Once the first computing device and second computing device(s) are connected, their respective companion applications can exchange metadata to confirm the second computing device(s) and/or their respective applications are authorized to receive the data the first computing device is sharing. Once authorization is confirmed, the first computing device may send the application data to the second computing device via their companion applications. The companion application(s) of the second computing device(s) can then provide the application data to their relevant authorized applications.

Thus, the techniques outlined in this disclosure describe a primary computing device, logged into a user account, seamlessly sharing application data with one or more secondary computing devices under the same user account. The efficiency of this data exchange is orchestrated by the primary device, which strategically determines a connection method to connect to the secondary devices. The primary computing device conducts an efficient connection and data sharing process by leveraging a multitude of connectivity heuristics and contextual factors.

Companion applications, installed on each computing device, play a pivotal role in enabling communication and data sharing. Once the connection between the primary and secondary devices is established, their respective companion applications engage in metadata exchange to validate the authorization of the second computing device(s) and their corresponding applications to receive the shared data. Following authorization confirmation, the primary computing device transmits the application data through their companion application, ensuring a secure and authorized transfer. The companion application(s) on the receiving end then deliver the application data to their designated authorized applications, creating a streamlined and secure data-sharing ecosystem.

The techniques described herein thus enable developers to simply send all communications their apps wish to share with other computing devices of the same user to the same place, the companion application, which then determines the communication protocols and pathways to use to share the application data. This allows developers to enable their applications to interact with more applications and computing devices without having to set up application systems that determine and establish different communication pathways in different contexts. Other advantages of this approach include heightened security through stringent authorization checks, optimized data transfer methods based on contextual heuristics, and a seamless integration of shared data into the recipient applications, enhancing user experience and operational efficiency.

In some aspects, the techniques described herein relate to a method including: receiving, by a first application executing at a first computing device and from a second application installed on the first computing device, a request to send data to a second computing device, wherein the first computing device and the second computing device are each associated with a user; determining, by the first application, whether the second computing device is reachable using a first network communication protocol; in response to determining that the second computing device is reachable using the first network communication protocol, transmitting, by the first computing device, the data to the second computing device over the first network communication protocol; and in response to determining that the second computing device is not reachable using the first network communication protocol: transmitting, by the first computing device, the data to the second computing device over a second network communication protocol.

In some aspects, the techniques described herein relate to a system including one or more processors and a non-transitory computer-readable medium comprising instructions stored therein, which when executed by the one or more processors, cause the one or more processors to perform operations comprising: receiving, by a first application executing at a first computing device and from a second application installed on the first computing device, a request to send data to a second computing device, wherein the first computing device and the second computing device are each associated with a user; determining, by the first application, whether the second computing device is reachable using a first network communication protocol; in response to determining that the second computing device is reachable using the first network communication protocol, transmitting, by the first computing device, the data to the second computing device over the first network communication protocol; and in response to determining that the second computing device is not reachable using the first network communication protocol: transmitting, by the first computing device, the data to the second computing device over a second network communication protocol.

In some aspects, the techniques described herein relate to a non-transitory machine-readable medium comprising instructions stored therein, which when executed by a one or more processors of a first computing device, cause the one or more processors to: execute a first application; receive, via the first application and from a second application installed on the first computing device, a request to send data to a second computing device, wherein the first computing device and the second computing device are each associated with a user; determine whether the second computing device is reachable using a first network communication protocol; in response to determining that the second computing device is reachable using the first network communication protocol, send the data to the second computing device over the first network communication protocol; and in response to determining that the second computing device is not reachable using the first network communication protocol, send the data to the second computing device over a second network communication protocol.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example network environment, in accordance with the techniques of this disclosure.

FIG. 2 is a conceptual diagram that exemplifies a system wherein a computing device employs one or more techniques from this disclosure.

FIG. 3 illustrates a particular example of two computing devices communicating with one another, in accordance with techniques from this disclosure.

FIG. 4 shows a flowchart illustrating an example process for transmitting application data from one computing device to another, in accordance with various aspects of the subject technology.

### DETAILED DESCRIPTION

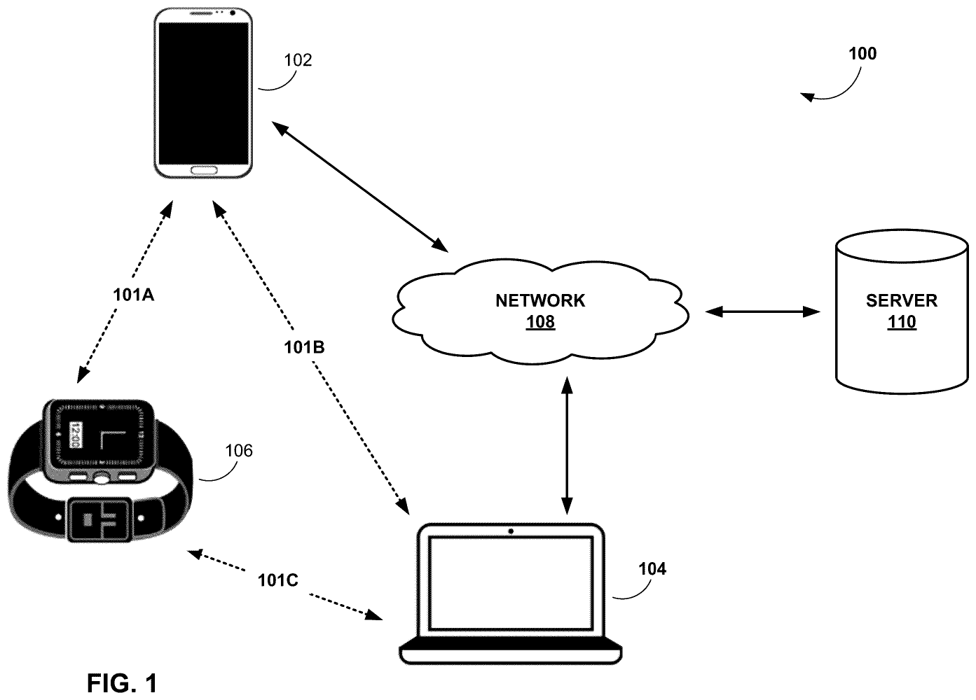

FIG. 1 illustrates an example network environment, in accordance with the techniques of this disclosure. The network environment 100 includes first computing device 102, second computing device 104, and third computing device 106, which are all associated with a particular user account. First computing device 102, second computing device 104, and third computing device 106 may communicate with each other through peer-to-peer connection(s), direct links 101A-C which directly communicatively couple computing devices without requiring an intermediary device such as server 110 or a WI-FI router. In some examples, the network environment 100 may also comprise a server 110. First computing device 102 and second computing device 104 may communicate with server 110 through a network 108. Network 108 represents any public or private data transmission network, for instance, a cellular, WI-FI, and/or other type of network for transmitting data between computing devices. In some examples of network environment 100, third computing device 106 may also be able to communicate with server 110 through network 108. Server 110 can include one or more computing devices (e.g., one or more servers) and one or more data stores. Each of first computing device 102, second computing device 104, and third computing device 106 may include one or more applications installed on the respective computing devices. Additionally, each of first computing device 102, second computing device 104, and third computing device 106 may include a particular application, which shall be referred to as a “companion application” herein, that allows the first computing device 102, second computing device 104, and third computing device 106 to communicate with one another. The companion application can include any first-party or native application installed on or otherwise integrated into the respective computing devices 102, 104, 106 and capable of communicating with: the operating systems of the respective computing devices 102, 104, 106; the applications installed on the respective computing devices 102, 104, 106; the other instances of companion applications installed on the other computing devices 102, 104, 106 and/or the other computing devices 102, 104, 106 themselves; and server 110.

First computing device 102, second computing device 104, and third computing device 106 may be systems or devices having a processor, a memory, and communication capability for exchanging data with other computing devices. First computing device 102, second computing device 104, and third computing device 106 may have capabilities to display information and to receive user input on the respective computing devices. By way of example and not of limitation, computing devices can include a desktop computer, a laptop computer, a handheld computer, a tablet, a mobile phone, a tablet computer, a portable gaming device, an e-book reader, an automobile computing platform or system, a smart watch, a fitness tracker, a network appliance, a camera, a smart phone, a media player, a navigation device, an email device, a game console, television, set-top box or a combination of any of these computing devices or other computing devices.

Server 110 may be any system or device having a processor, a memory, and communications capability for exchanging data with other computing devices, including for example, first computing device 102, second computing device 104, and third computing device 106. Server 110 may be associated with each instance of companion application 218 installed on a computing device associated with a given user account. Server 110 receive user identification information and user authentication information from each of first computing device 102, second computing device 104, and third computing device 106. The server 112 may authenticate, for each of first computing device 102, second computing device 104, and third computing device 106, respective user identification information with respective user authentication information and transmit user verification information to the respective computing device. User verification information may comprise information associated with whether the user identification information and the user authentication information received by the server 110 matches those stored in the server 110. Authentication may further include determining whether computing devices that are the target of communications are logged into the user account, and that the target computing devices include applications that are authorized to receive those communications. In some examples, server 110 can include a single computing device. In other implementations, server 110 can represent more than one computing device working together to perform the actions of a computer server (e.g., server farm). Further, the server 110 can represent various forms of servers including, but not limited to, a web server, an application server, a proxy server, a network server, or a server farm.

The computing devices, including first computing device 102, second computing device 104, and third computing device 106, may communicate with each other wirelessly through communication unit(s) which may include peer-to-peer interfaces and their digital signal processing circuitry. First computing device 102, second computing device 104, and third computing device 106 may not need the Internet to form a peer-to-peer connection between the devices. The communication unit(s) of first computing device 102, second computing device 104, and third computing device 106 may provide for communication under protocols such as BLUETOOTH, BLUETOOTH LOW ENERGY (BLE), NEAR FIELD COMMUNICATION (NFC), AND/OR WI-FI DIRECT. In cases where a peer-to-peer connection has been formed between two or more computing devices, the two computing devices and/or their respective two instances of the companion application executing on the sending and the receiving devices may perform the authentication procedures as described in more detail below.

Computing devices 102, 104, and/or 106 may also communicate with server 110 wirelessly through their communication unit(s) which may include network interfaces and associated digital processing circuitry. These network interfaces may provide for communications under various modes or protocols, for example, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA) CDMA2000, or General Packet Radio System (GPRS), WI-FI, etc. For example, the communication may occur through a radio-frequency transceiver (not shown).

In one example, first computing device 102 and/or its respective companion application may receive a request to transmit application data from a maps application installed on first computing device 102 to share maps application data with second computing device 104. First computing device 102 and/or its respective companion application may determine whether second computing device 104 is currently connected to first computing device 102 via BLUETOOTH, for example. If the two devices are not connected over BLUETOOTH, first computing device 102 may scan the environment for BLUETOOTH signals of second computing device 104 advertising that second computing device 104 is available for BLUETOOTH connections. If first computing device 102 discovers such a pairing signal from second computing device 104, then first computing device 102 may initiate BLUETOOTH pairing with second computing device 104.

Once first computing device 102 and second computing device 104 are connected via BLUETOOTH, first computing device 102 and/or its respective companion application will send an authorization request to the separate instance of the companion application installed on second computing device 104. This authorization request may include any sort of request for information about applications installed on second computing device 104, and/or may include the type of application data to be transferred. For example, first computing device 102 and/or its respective companion application may provide a type of application data to be transferred and/or a request for confirmation that second computing device 104 includes applications authorized to receive the application data. Second computing device 104 and/or its respective separate instance of the companion application may provide a response transmission that includes a yes/no indication that it includes application(s) authorized to receive the data and/or application identifiers identifying the particular applications installed on second computing device 104 and authorized to receive the application data. If second computing device 104 and/or its respective companion application confirm that second computing device 104 includes applications authorized to receive the application data, then first computing device and/or its respective companion application will transmit the application data to second computing device 104 and/or its respective separate instance of the companion application. When second computing device 104 and/or its respective separate instance of the companion application receive the application data, it will then provide it to one or more of the authorized applications of second computing device 104. Thus, for example, second computing device 104 will receive the maps application data and provide it to an authorized maps application executing on second computing device, causing the maps application to display a particular location to be presented to the user of second computing device 104.

First computing device 102, second computing device 104, and third computing device 106, and/or their respective instances of the companion application, may have access to developer-defined parameters for the applications installed on their respective devices which include rules or guidelines for which applications can receive their application data. These developer-defined parameters may be included in the applications, included in the application data transmission requests received from the applications, or received from server 110. Thus, for instance, the request to transmit maps application data received by first computing device 102 from the maps application may have included an indication that only maps, navigation, and web browser applications of second computing device 104 should be able to access the application data indicated by the request.

First computing device 102, second computing device 104, and third computing device 106, and/or their respective instances of the companion application, may receive application data from their respective installed applications that is directed to a target computing device of the user logged into the same account, for example second computing device 104 and/or third computing device 106. The computing devices 102, 104, 106 and/or their companion applications may be configured to determine/select the path to get that application data to the target computing device using a plurality of connectivity heuristics and based on various factors such as proximity, type of available connections, data packet size, expected latency, network traffic conditions, device load, battery levels, available network communication protocols, communication protocol range, signal strength, type of data to be transmitted, user account information, network security protocols, information specified by the developers of the applications, and/or prioritized quality of service parameters. In some examples, each of the plurality of connectivity heuristics may be respectively associated with one or more of a plurality of network communication protocols available to first computing device 102 such as BLUETOOTH, BLUETOOTH LOW ENERGY (BLE), NEAR FIELD COMMUNICATION (NFC), WI-FI DIRECT, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA) CDMA2000, or General Packet Radio System (GPRS), WI-FI, etc. Thus, for example, one or more of the plurality of connectivity heuristics may dictate that a computing device 102, 104, 106 and/or a companion application prioritize low-latency and low-power short-range wireless communication protocols over higher-latency and higher-power long-range communication protocols in examples where the application data packet size is small, the local area network traffic conditions are not ideal, the battery level is low, etc. For example, first computing device 102 and/or its respective instance of the companion application may determine whether second computing device 104 is reachable via a direct link 101B associated with a particular protocol (e.g., BLUETOOTH) for transmitting the application data to second computing device 104 in such conditions. However, if second computing device 104 is not reachable via direct link 101B and/or the particular protocol, then first computing device 102 and/or its respective instance of the companion application may, for example, instead determine to transmit the application data to server 110 via network 108, and server 110 may then transmit corresponding application data to second computing device 104, such that first computing device 102 and second computing device 104 are able to communicate with one another via an intermediary device, server 110. In some examples, rather than selecting network 108 and/or server 110, first computing device 102 and/or its respective companion application may determine to communicate with second computing device 104 via a direct link 101B associated with a second short-range wireless communication protocol (e.g., BLE) and/or to communicate with second computing device 104 by transmitting the application data to third computing device 106 (e.g., via direct link 101A) along with directions for third computing device 106 to transmit the application data to second computing device 104 (e.g., via direct link 101C).

In some examples, network 108 can be a large computer network such as, for example, a local area network (LAN), wide area network (WAN), the Internet, a cellular network, or a combination thereof connecting any number of mobile clients, fixed clients, and servers. Further, network 108 can include, but is not limited to, any one or more of the following network topologies, including a bus network, a star network, a ring network, a mesh network, a star-bus network, tree or hierarchical network, and the like. In some examples, communication between each client (e.g., first computing device 102 and second computing device 104) and server (e.g., server 110) can occur via a virtual private network (VPN), Secure Shell (SSH) tunnel, or other secure network connection. In some examples, network 108 may further include a corporate network (e.g., intranet) and one or more wireless access points. In some examples, any two of the computing devices 102, 104, 106 may communicate with one another via one or more intermediary computing devices, which may include server 110 (e.g., via network 108) and/or the other one of the computing devices 102, 104, 106 (e.g., over direct link(s) 101A-C).

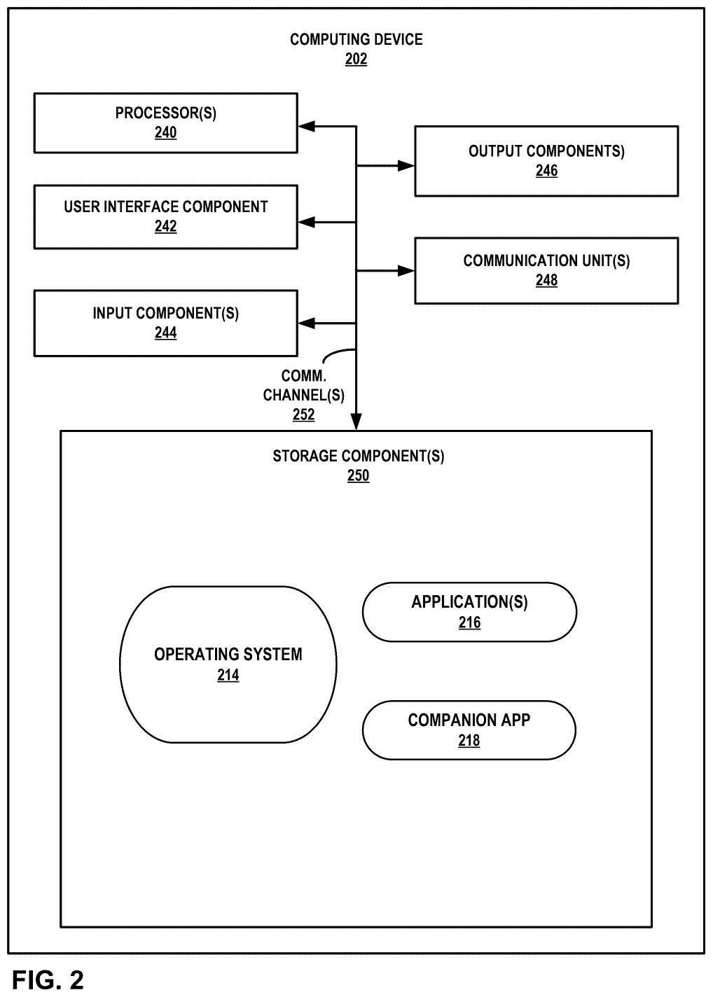

FIG. 2 is a conceptual diagram that exemplifies a system wherein a computing device employs one or more techniques from this disclosure. Not all of the components depicted in the figure may be used, and one or more implementations may include additional components not shown in the figure. Variations in the arrangement and type of the components may be made without departing from the scope of the subject technology. Additional components, different components, or fewer components may be included. For example, although computing device 202 is depicted in FIG. 2, the systems, processes, and components herein may also apply to first computing device 102, second computing device 104, or third computing device 106 of FIG. 1

Computing device 202 may include processor(s) 240, user interface component (UIC) 242, input component(s) 244, output component(s) 246, communication unit(s) 248, and storage component(s) 250. Storage components 250 of computing device 202 include operating system (OS) 214, application(s) 216, and companion application 218. Communication channels 252 may interconnect each of the components 240, 242, 244, 246, 248, and/or 250 for inter-component communications (physically, communicatively, and/or operatively). In some examples, communication channels 252 may include a system bus, a network connection, an inter-process communication data structure, or any other method for communicating data.

One or more input components 244 of computing device 202 may receive input. Examples of input are tactile, audio, and video input. Input components 244 of computing device 202, in one example, include a presence-sensitive display, touch-sensitive screen, mouse, keyboard, voice responsive system, video camera, microphone or any other type of device for detecting input from a human or machine.

One or more output components 246 of computing device 202 may generate output. Examples of output are tactile, audio, and video output. Output components 246 of computing device 202 may include, for example, a presence-sensitive display, sound card, video graphics adapter card, speaker, liquid crystal display (LCD), dot matrix display, light emitting diode (LED) display, microLED, organic light-emitting diode (OLED) display, e-ink, haptic motors, linear actuating devices, or any other type of device for generating output to a human or machine.

One or more communication units 248 of computing device 202 may communicate with external devices via one or more wired and/or wireless networks by transmitting and/or receiving network signals on the one or more networks. Examples of communication units 248 include a network interface card (e.g., such as an Ethernet card), an optical transceiver, a radio frequency transceiver, a GPS receiver, or any other type of device that can send and/or receive information. Other examples of communication components 248 may include BLUETOOTH, BLUETOOTH LOW ENERGY (BLE), NEAR FIELD COMMUNICATION (NFC), WI-FI DIRECT, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA) CDMA2000, or General Packet Radio System (GPRS), WI-FI, 3G, 4G, and 5G radios found in computing devices as well as Universal Serial Bus (USB) controllers and the like.

One or more processors 240 may implement functionality and/or execute instructions within computing device 202. For example, one or more processors 240 on computing device 202 may receive and execute instructions stored by storage components 250 that provide the functionality of operating system 226, UI module 206, remote management module 208, and device management module 224. These instructions executed by one or more processors 240 may cause computing device 202 to store and/or modify information, within storage component(s) 250 during program execution. One or more processors 240 may execute instructions of operating system 214, companion application 218, and application(s) 216. That is, operating system 214, companion application 218, and application(s) 216 may be operable by one or more processors 240 to perform various functions described herein.

One or more processors 240 may be or include a digital signal processor (DSP), a general purpose microprocessor, application specific integrated circuit (ASIC), field programmable logic array (FPGA), and/or other equivalent integrated or discrete logic circuitry. One or more input components 244 of computing device 202 may be configured to receive input. Examples of input are tactile, audio, and video input. Input component(s) 244 of computing device 202, in one example, include a presence-sensitive display, touch-sensitive screen, mouse, keyboard, voice responsive system, video camera, microphone or any other type of device for detecting input from a human or machine.

In some examples, UIC 242 of computing device 202 may include functionality of input component(s) 244 and/or output component(s) 246. In the example of FIG. 2, UIC 242 may be or may include a presence-sensitive input device, such as a presence-sensitive display (e.g., a touchscreen). In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x,y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, a presence sensitive input device also provides output to a user using tactile, audio, or video stimuli as described with respect to one or more output component(s) 246, e.g., at a display. In the example of FIG. 2, UIC 242 may present a user interface.

While illustrated as an internal component of computing device 202, UIC 242 also represents an external component that shares a data path with computing device 202 for transmitting and/or receiving input and output. For instance, in one example, UIC 242 represents a built-in component of computing device 202 located within and physically connected to the external packaging of computing device 202 (e.g., a screen on a mobile phone). In another example, UIC 242 represents an external component of computing device 202 located outside and physically separated from the packaging of computing device 202 (e.g., a monitor, a projector, etc. that shares a wired and/or wireless data path with a tablet computer).

One or more storage components 250 within computing device 202 may store information for processing during operation of computing device 202 (e.g., computing device 202 may store data accessed by OS 214, applications 216, and/or companion application 218 during execution at computing device 202). In some examples, storage components 250 may be configured for temporary memory, meaning that a primary purpose of storage components 250 is not long-term storage. Storage components 250 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 250, in some examples, also include one or more computer-readable storage media. Storage components 250 may be configured to store larger amounts of information than volatile memory. Storage components 250 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage components 250 may store program instructions and/or information (e.g., data) associated with OS 214, applications 216, and/or companion application 218 to enable the functions described herein.

Applications 216 may represent first party applications developed and provided as applications integrated into OS 214 and/or third-party applications that the user of computing device 202 obtains via application store services provided by way of OS 214. Applications 216 may extend software functionality of computing device 202, where applications 216 may execute within an execution environment presented by OS 214. Applications 216 may, for example, provide navigation services, fitness tracking services, gaming services (e.g., video games), email services, web browsing services, texting and/or chat services, web conferencing services, video conferencing services, music services (including streaming music services), video services (including video streaming services), location services, word processing services, spreadsheet services, slide and/or presentation services, assistant services, text entry services, or any other service commonly provided by applications. For purposes of this disclosure, applications 216 may include widgets. Applications 216 of computing device 202 have the capability to request task execution from companion application 218 and OS 214.

Companion application 218 may represent a first-party or native application installed on (or otherwise integrated into) computing device 202 as well as any other computing device that computing device 202 is to communicate with over peer-to-peer protocols, such as second computing device 104 and/or third computing device 106 of FIG. 1. A common user may be logged in to (or otherwise authenticated in) companion application 218 using the same user account on each of their computing devices. Companion application 218 may include an application services app usable by the user, OS 214, and applications 216 to perform various tasks. For example, companion application 218 may be an application services and store app that allows the user to install/uninstall applications and set universal settings for applications, allows OS 214 to check for updates to installed applications 218 and have them automatically updated, and allows applications 216 to transmit application data to related applications executing on separate target computing device(s) associated with the same user account.

Companion application 218 may receive application data from applications 216 that is directed to a target computing device of the user logged into the same account, for example second computing device 104 and/or third computing device 106 of FIG. 1. Companion application 218 may be configured to determine a particular path or communication protocol to get that application data to the target computing device based on a plurality of rules regarding which types of direct communication links and/or network connections should be established in which situations (i.e., a plurality of connectivity heuristics) and based on various contextual factors such as proximity, type of available connections, data packet size, expected latency, network traffic conditions, device load, battery levels, available network communication protocols, communication protocol range, signal strength, type of data to be transmitted, user account information, network security protocols, information specified by the developers of applications 216, and/or prioritized quality of service parameters.

In some examples, each of the plurality of connectivity heuristics may be respectively associated with one or more of a plurality of network communication protocols available to computing device 202 such as BLUETOOTH, BLUETOOTH LOW ENERGY (BLE), NEAR FIELD COMMUNICATION (NFC), WI-FI DIRECT, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA) CDMA2000, or General Packet Radio System (GPRS), WI-FI, etc. Thus, for example, one or more of the plurality of connectivity heuristics may dictate that companion application 218 prioritize low-latency and low-power short-range wireless communication protocols over higher-latency and higher-power long-range communication protocols in examples where the application data packet size is small, the local area network traffic conditions are not ideal, the battery level is low, etc. The plurality of connectivity heuristics may include, for example, a connectivity heuristic that prioritizes BLUETOOTH for short-range device pairing when the sending and receiving computing devices are able to pair over BLUETOOTH. Another example may be a connectivity heuristic that prioritizes BLE for short-range communication with Internet of Things (IoT) devices and other so-called “smart devices” that have limited battery life, and/or that prioritizes BLE for any type of computing device when its battery level is low. Yet another example may be a connectivity heuristic that prioritizes communicating via a server over WI-FI for high-volume data transfers or when a receiving computing device is unreachable via one or more short-range wireless communication protocols. In some examples, a connectivity heuristic may involve several communication protocols and/or contextual factors. For example, a connectivity heuristic may prioritize BLUETOOTH when a receiving device is reachable via BLUETOOTH, the battery level of the sending device is above 20%, and the data packet size is small; may prioritize BLE when the device is reachable over BLE, when the device is either not reachable via BLUETOOTH or the battery level of the sending device is below 20%, and when the data packet size is small; and may prioritize sending the data via the server and local WI-FI network when data packet size is high and/or the target device is not reachable over BLUETOOTH and BLE.

Companion application 218 on computing device 202 may receive application data from one or more applications 216 of computing device 202. Another instance of companion application 218 may be included on the target computing device to which computing device 202 is sending the application data from applications 216. The target computing device may also include a separate instance of the one or more of applications 216 that has sent the request to transmit the application data to companion application 218 on computing device 202, or the target computing device may include one or more related applications authorized by the developers of the applications 216 sending the application data from computing device 202. Before transmitting the application data to the target computing device, companion application 218 on first computing device will provide information about the application data and the one or more of applications 216 that are sending the application data to a separate instance of companion application 218 executing at the target computing device and receive a response from the separate instance of companion application 218 that tells companion application 218 of computing device 202 whether the target computing device includes one or more applications authorized to receive the application data. Once authorization is performed, companion application 218 will transmit the application data to the separate instance of companion application 218 executing on the target computing device, where that separate instance of companion application 218 will then pass on that application data to the one or more applications installed on the target computing device that are authorized to receive it.

Computing device 202 may communicate with other computing devices wirelessly through communication unit(s) 248 which may include peer-to-peer interfaces and their digital signal processing circuitry. Computing device 202 may not need the Internet to form a peer-to-peer connection with one or more other computing devices. As discussed herein, communication unit(s) 248 may provide for several short-range wireless communication protocols such as BLUETOOTH, BLUETOOTH LOW ENERGY (BLE), NEAR FIELD COMMUNICATION (NFC), AND/OR WI-FI DIRECT. In cases where a peer-to-peer connection has been formed between two or more computing devices, the two instances of companion application 218 executing on the sending and the receiving devices may perform the authentication procedures as described herein.

Computing device 202 may also communicate with a server, such as server 110 of FIG. 1, wirelessly through communication unit(s) 248 which may include network interfaces and their digital processing circuitry. As described herein, network interfaces may provide for several long-range wireless communication protocols, for example, Global System for Mobile communication (GSM) voice calls, Short Message Service (SMS), Enhanced Messaging Service (EMS) or Multimedia Messaging Service (MMS) messaging, Code Division Multiple Access (CDMA), Time Division Multiple Access (TDMA), Personal Digital Cellular (PDC), Wideband Code Division Multiple Access (WCDMA) CDMA2000, or General Packet Radio System (GPRS), WI-FI, etc. For example, the communication may occur through a radio-frequency transceiver (not shown).

In one example, computing device 202 may receive a request to transmit application data from a maps application (e.g., one of applications 216) installed on computing device 202 to share maps application data with a target computing device, for example second computing device 104 of FIG. 1. Computing device 202 may determine whether second computing device 104 is currently connected to computing device 202 via BLUETOOTH, for example. If the two devices are not connected over BLUETOOTH, computing device 202 may scan the environment for BLUETOOTH signals of second computing device 104 advertising that second computing device 104 is available for BLUETOOTH connections. If computing device 202 discovers such a pairing signal from second computing device 104, then computing device 202 may initiate BLUETOOTH pairing with second computing device 104.

Once computing device 202 and second computing device 104 are connected via BLUETOOTH, companion application 218 installed on computing device 202 will send an authorization request to the separate instance of companion application 218 installed on second computing device 104. This authorization request may include any sort of request for information about applications installed on second computing device 104, and/or may include the type of application data to be transferred. For example, the first instance of companion application 218 may provide a type of application data to be transferred and an indication that second computing device 104 includes applications authorized to receive the application data. The second instance of companion application 218 that is executing on second computing device 104 may provide a response transmission that includes a yes/no indication that it includes application(s) authorized to receive the data and/or application identifiers identifying the particular applications installed on second computing device 104 and authorized to receive the application data. When the second instance of companion application 218 receives the application data, it will then provide it to one or more of the authorized applications of second computing device 104.

All instances of companion application 218 may have access to developer-defined parameters for applications 216 installed on their respective devices which include rules or guidelines for which applications can receive their application data. These developer-defined parameters may be included in applications 216, included in the application data transmission requests received from applications 216, or received from server 110. Thus, for instance, the request to transmit maps application data received by computing device 202 from the maps application may have included an indication that only maps, navigation, and web browser applications of second computing device 104 should be able to access the application data indicated by the request.

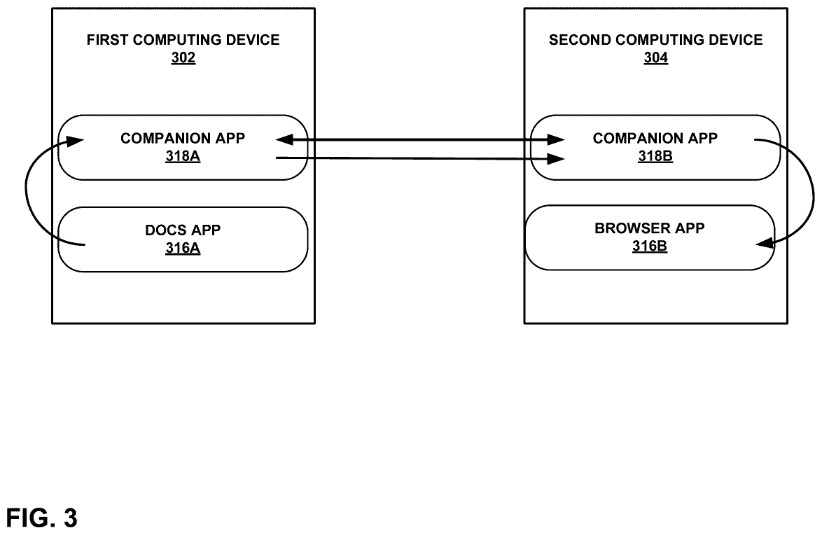

FIG. 3 illustrates a particular example of two computing devices communicating with one another, in accordance with techniques from this disclosure. While example of FIG. 3 is discussed with respect to first computing device 302 and second computing device 304, it should be appreciated that the methods and processes discussed with respect to FIG. 3 may be performed by any of the computing devices discussed herein.

In the example of FIG. 3, a particular user is logged into both first computing device 302 and second computing device 304 with the same user account (or otherwise authenticated on both first computing device 302 and second computing device 304). First computing device 302 may include companion application 318A as well as a documents application 316A capable of creating and/or editing documents. Second computing device may include companion application 318B and browser application 316A capable of presenting website pages. The particular user may be viewing a document on first computing device 302, which may be a mobile device as first computing device 102 is depicted in FIG. 1, and they may decide that they want to view the document on the bigger screen of second computing device 304, which may be a laptop as second computing device 104 is depicted in FIG. 1. In order to accomplish this, the user may select some kind of “share” option within their documents application 316A that allows them to select second computing device 304 to receive the document the user is viewing.

When documents application 316A of first computing device 302 determines to share application data (e.g., a copy of the particular document) with second computing device 304, it sends request data to companion application 318A as depicted in FIG. 3. The request may include the application data to be sent (e.g., a link and/or deep link to the document the user is viewing) as well as an identifier of the intended recipient device (second computing device 304).

Companion application 318A of first computing device 302 will then prepare request metadata indicating the type of application data to be sent or the types of applications authorized to receive the application data and determine how to communicate with the instance of companion application 318B executing at second computing device 304. Companion application 318A may begin by determining whether first computing device 302 is currently connected to second computing device 304 via one or more short-range wireless communication protocols (e.g., BLUETOOTH). If first computing device 302 is currently connected to second computing device 304 then companion application 318A may initiate sending the request metadata to companion application 318B of second computing device 304. If first computing device 302 is not currently connected to second computing device 304, then companion application 318A may determine if second computing device is nearby and reachable using one or more short-range wireless communication protocols, for example by scanning the environment for BLUETOOTH pairing signals (e.g., signals indicating a device is available for BLUETOOTH connection) associated with second computing device 304. If companion application 318A determines that second computing device 304 is nearby and reachable, it will cause first computing device 302 to establish a direct link with second computing device 304 over a particular short-range wireless communication protocol (e.g., pairing over BLUETOOTH) and then send the request metadata. If companion application 318A does not determine that second computing device 304 is nearby and reachable, then companion application 318A of first computing device 302 may send the request metadata to companion application 318B of second computing device 304 via a network (e.g., network 108) and a server (e.g., server 110), as discussed herein.

When companion application 318B executing at second computing device 304 receives the request metadata sent by companion application 318A of first computing device, it unpacks the metadata to determine the request requirements and then generates response metadata based on the request metadata, the applications installed on second computing device 304, the applications authorized to receive the application data, and any developer-provided information relevant to documents application 316A. The response metadata generated by companion application 318B may include binary (e.g., yes/no) indications that second computing device 304 includes one or more applications authorized to receive the application data, and/or may include particular application identifiers identifying the one or more applications installed on second computing device 304 that are authorized and capable of processing the application data. For example, in FIG. 3, second computing device 304 does not include a documents application, but does include a browser application 316B that either or both of companion application(s) 318A-B have determined is authorized and capable of receiving and processing the application data. Companion application 318B sends the response metadata back to companion application 318A executing on first computing device 302, where companion application 318A determines that second computing device 304 and/or browser application 316B is authorized and capable of receiving and processing the application data, as depicted.

After companion application 318A of first computing device 302 receives the response metadata from companion application 318B of second computing device 304, it unpacks the metadata to determine that second computing device 304 and/or browser application 316B are authorized to receive the application data. Once this has been determined, companion application 318A sends the application data to companion application 318B of second computing device 304 over the direct link or network connection mentioned above. Once companion application 318B receives the application data, it provides it to browser application 316B which is authorized to receive and process it. Browser application 316B may then, for example, process the application metadata in order to open an html document that corresponds to the document the user was viewing on their documents application 316A executing at first computing device 302.

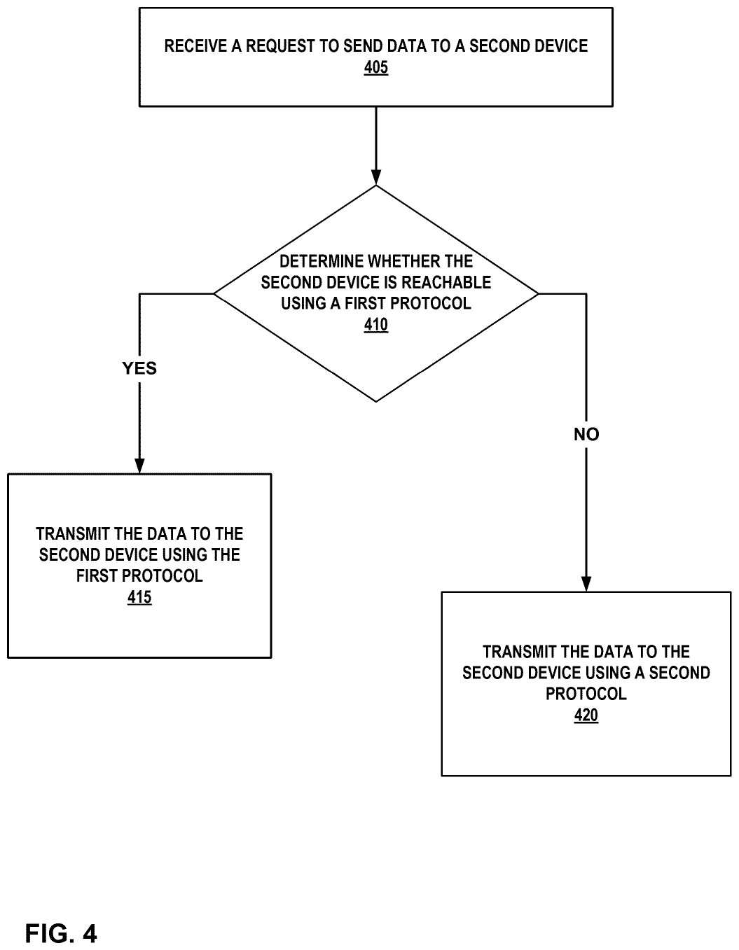

FIG. 4 shows a flowchart illustrating an example process for transmitting application data from one computing device to another, in accordance with various aspects of the subject technology. The steps depicted in FIG. 4 do not need to be performed in the order shown. It is understood that the depicted order is an illustration of one or more example approaches, and the subject technology is not meant to be limited to the specific order or hierarchy presented. The steps can be rearranged, and/or two or more of the steps can be performed simultaneously. Moreover, while examples are discussed with respect to first computing device 302 and second computing device 304 of FIGS. 1 and 3, it should be appreciated that the methods and processes discussed with respect to FIG. 4 may be performed by any of the computing devices discussed herein. For example purposes of FIG. 4, first computing device 302 and second computing device 304 of FIG. 3 are considered to be the same first computing device 102 and second computing device 104 depicted in FIG. 1.

In block 405 of FIG. 4, companion application 318A of first computing device 302 receives a request from an application 316A installed on first computing device 302 to send application data to second computing device 304, while both first computing device 302 and second computing device 304 are logged into the same user account on their respective companion applications 318A-B. For example, an application services and store app of a mobile phone may receive a request from a document editing application installed on the mobile phone to send application data including an editable text document to a user's laptop in response to the user requesting the editable text document be shared with their laptop so that they may view or edit the document on a bigger screen. In some implementations, the request itself may specify the applications installed on second computing device 304 that are authorized to receive the application data, or the respective instances of companion applications 318A-B installed on first computing device 302 and second computing device 304 may have access to developer-defined data indicating which applications are authorized to receive which types of application data from other applications and/or devices.

At block 410, companion application 318A of first computing device 302 determines whether second computing device 304 is reachable using a first network communication protocol. Companion application 318A of first computing device 302 may select the first network communication protocol for communicating with second computing device 304 based on: a plurality of rules regarding which types of direct communication links and/or network connections should be established in which situations (i.e., a plurality of connectivity heuristics) that take into account several contextual factors including but not limited to: proximity, type of available connections, data packet size, expected latency, network traffic conditions, device load, battery levels, available network communication protocols, communication protocol range, signal strength, type of data to be transmitted, user account information, network security protocols, information specified by developers of applications, and/or prioritized quality of service parameters. For example, the application services and store app of the mobile phone may select the BLUETOOTH communication protocol for communicating with the laptop based on the application data packet size being small, the local area network traffic conditions being not ideal, the battery level being low, and satisfying the criteria set forth by the associated BLUETOOTH connectivity heuristic.

At block 410, in order to determine whether second computing device 304 is reachable using the first network communication protocol (e.g., BLUETOOTH), companion application 318A may determine whether first computing device 302 and second computing device 304 are currently connected via the first network communication protocol (i.e., direct link 101B). In some examples, if first computing device 302 and second computing device 304 are not currently connected via direct link 101B, then companion application 318A may cause first computing device 302 to perform a signal scan for first network communication protocol pairing signals being emitted by second computing device 304 (e.g., BLUETOOTH pairing signals emitted by second computing device 304 to let computing devices in the environment know it is available for pairing). If a first network communication protocol pairing signal associated with second computing device 304 is detected, then companion application 318A may cause first computing device 302 to establish the direct link 101B between first computing device 302 and second computing device 304. In some examples, companion application 318A may communicate with server 110 via network 108 to determine if second computing device 304: (a) is associated with the user account, (b) is capable of communicating with first computing device 302 over the first network communication protocol, and/or (c) is communicatively coupled with server 110. Based on the information received from server 110, companion application 318A may request that second computing device 304 be made available for pairing over the first network communication protocol, and server 110 may send data to companion application 318B to cause companion application 318B to cause second computing device 304 to broadcast the pairing signal and/or to automatically establish direct link 101B with first computing device 302 using a first network communication protocol pairing signal being emitted by first computing device 302.

In some examples, companion application 318A may communicate with server 110 via network 108 to identify a plurality of computing devices associated with the user account of the user and a plurality of communication links between two or more of the plurality of computing devices, such that companion application 318A may request that server 110 establish an indirect communication route between intermediary computing devices. For example, third computing device 106 of FIG. 1 may not be connected to server 110 via network 108. Third computing device 106 may be able to communicate with server 110, and any computing devices also in communication with server 110, via links 101A and 101C. Thus, in order to send application data to third computing device 106 when link 101A is not available, companion application 318A and/or server 110 may determine to send the data from server 110 to second computing device 304 which is directly connected, via link 101C, to third computing device 106.

Once it is determined that first computing device 302 and second computing device 304 are connected over the first network communication protocol (e.g., direct link 101B), then it is determined that second computing device 304 is reachable using the first network communication protocol (“YES”) and the process proceeds to block 415. If direct link 101B cannot be established at 410 (“NO”), then the process proceeds to block 420.

At block 415, companion application 318A causes first computing device 302 to transmit the application data to companion application 318B executing on second computing device 304 via the first network communication protocol (e.g., via direct link 101B). For example, the application services and store app of the mobile phone may transmit application data/metadata identifying the document the user was viewing on their mobile phone to the application services and store app of the laptop. The application services and store app of the laptop may then pass the application data/metadata to an application (e.g., application 316B) installed on the laptop that is authorized to receive the application data/metadata, thereby allowing the user to view the document on second computing device 304. In some examples, at block 415, companion application 318A of first computing device 302 and companion application 318B of second computing device 304 may first exchange metadata to confirm that second computing device 304 and/or application 316B are authorized to receive the application data/metadata, as described herein.

At block 420, companion application 318A causes first computing device 302 to transmit the application data to companion application 318B executing on second computing device 304 via a second network communication protocol. Companion application 318A may determine a plurality of network communication protocols available to first computing device 302 and/or second computing device 304. A second network communication protocol may be selected from among the plurality at block 420 and may include any network communication protocol other than the first network communication protocol. For example, in some implementations, companion application 318A may determine that another short-range wireless communication protocol is available to establish a direct peer-to-peer connection with second computing device 304 in a similar manner as described above. As another example, companion application 318A may select, according to the connectivity heuristics and contextual factors described herein, the indirect link to second computing device 304 through server 110 via network 108 for transmitting the application data/metadata. Once the second communication protocol is identified/selected, then companion application 318A will transmit (either directly or indirectly) the application data/metadata to companion application 318B executing on second computing device 304 at block 420. Companion application 318B may then provide the application data/metadata to application 316B executing on second computing device, causing application 316B to provide related data (e.g., present the document the user was viewing) on second computing device 304.

This disclosure includes the following examples.

Example 1. A method, comprising: receiving, by a first application executing at a first computing device and from a second application installed on the first computing device, a request to send data to a second computing device, wherein the first computing device and the second computing device are each associated with a user; determining, by the first application, whether the second computing device is reachable using a first network communication protocol; in response to determining that the second computing device is reachable using the first network communication protocol, transmitting, by the first computing device, the data to the second computing device over the first network communication protocol; and in response to determining that the second computing device is not reachable using the first network communication protocol: transmitting, by the first computing device, the data to the second computing device over a second network communication protocol.

Example 2. The method of example 1, wherein the first network communication protocol is a short-range wireless network communication protocol that directly communicatively couples the first computing device and the second computing device, and wherein the second network communication protocol is a network protocol that communicatively couples the first computing device and the second computing device via at least one intermediate device.

Example 3. The method of any of examples 1 and 2, further comprising: identifying a plurality of communication protocols available to the first computing device for transmitting the data to the second computing device; and selecting the second communication protocol of the plurality of communication protocols based on a plurality of connectivity heuristics each respectively associated with one or more of the plurality of communication protocols available to the first user device.

Example 4. The method of example 3, wherein the plurality of connectivity heuristics includes rules used to select from among the plurality of communication protocols available to the first computing device based on one or more of the following: communication protocol range, signal strength, type of data to be transmitted, and user account information.

Example 5. The method of any of examples 1-4, wherein a separate instance of the first application is installed on the second computing device, and wherein the user is authenticated on each instance of the first application.

Example 6. The method of example 5, wherein transmitting the data to the second computing device over the second network communication protocol includes transmitting the data to a server associated with the first application.

Example 7. The method of any of examples 1-6, further comprising: establishing, by the first computing device, a direct communication link with the second computing device in accordance with either the first network communication protocol or the second network communication protocol.

Example 8. The method of any of examples 1-7, wherein determining whether the second computing device is reachable using the first network communication protocol includes: identifying a plurality of devices associated with a user account of the user, wherein the plurality of devices includes the first computing device and the second computing device; and identifying a plurality of communication links between two or more of the plurality of devices.

Example 9. A system, comprising: one or more processors; and a non-transitory computer-readable medium comprising instructions stored therein, which when executed by the one or more processors, cause the one or more processors to perform operations comprising: receiving, by a first application executing at a first computing device and from a second application installed on the first computing device, a request to send data to a second computing device, wherein the first computing device and the second computing device are each associated with a user; determining, by the first application, whether the second computing device is reachable using a first network communication protocol; in response to determining that the second computing device is reachable using the first network communication protocol, transmitting, by the first computing device, the data to the second computing device over the first network communication protocol; and in response to determining that the second computing device is not reachable using the first network communication protocol: transmitting, by the first computing device, the data to the second computing device over a second network communication protocol.

Example 10. The system of example 9, wherein the first network communication protocol is a short-range wireless network communication protocol that directly communicatively couples the first computing device and the second computing device, and wherein the second network communication protocol is a network protocol that communicatively couples the first computing device and the second computing device via at least one intermediate device.

Example 11. The system of any of examples 9 and 10, the operations further comprising: identifying a plurality of communication protocols available to the first computing device for transmitting the data to the second computing device; and selecting the second communication protocol of the plurality of communication protocols based on a plurality of connectivity heuristics each respectively associated with one or more of the plurality of communication protocols available to the first user device.

Example 12. The system of example 11, wherein the plurality of connectivity heuristics includes rules used to select from among the plurality of communication protocols available to the first computing device based on one or more of the following: communication protocol range, signal strength, type of data to be transmitted, and user account information.

Example 13. The system of any of examples 9-12, wherein a separate instance of the first application is installed on the second computing device, and wherein the user is authenticated on each instance of the first application.

Example 14. The system of example 13, wherein transmitting the data to the second computing device over the second network communication protocol includes transmitting the data to a server associated with the first application.

Example 15. The system of any of examples 9-14, the operations further comprising: establishing, by the first computing device, a direct communication link with the second computing device in accordance with either the first network communication protocol or the second network communication protocol.

Example 16. The system of any of examples 9-15, wherein determining whether the second computing device is reachable using the first network communication protocol includes: identifying a plurality of devices associated with a user account of the user, wherein the plurality of devices includes the first computing device and the second computing device; and identifying a plurality of communication links between two or more of the plurality of devices.

Example 17. A non-transitory machine-readable medium comprising instructions stored therein, which when executed by a machine, cause the machine to perform operations comprising: receiving, by a first application executing at a first computing device and from a second application installed on the first computing device, a request to send data to a second computing device, wherein the first computing device and the second computing device are each associated with a user; determining, by the first application, whether the second computing device is reachable using a first network communication protocol; in response to determining that the second computing device is reachable using the first network communication protocol, transmitting, by the first computing device, the data to the second computing device over the first network communication protocol; and in response to determining that the second computing device is not reachable using the first network communication protocol: transmitting, by the first computing device, the data to the second computing device over a second network communication protocol.

Example 18. The non-transitory machine-readable medium of example 17, the operations further comprising: identifying a plurality of communication protocols available to the first computing device for transmitting the data to the second computing device; and selecting the second communication protocol of the plurality of communication protocols based on a plurality of connectivity heuristics each respectively associated with one or more of the plurality of communication protocols available to the first user device.

Example 19. The non-transitory machine-readable medium of any of examples 17 or 18, the operations further comprising: establishing, by the first computing device, a direct communication link with the second computing device in accordance with either the first network communication protocol or the second network communication protocol.

Example 20. The non-transitory machine-readable medium of any of examples 17-19, wherein determining whether the second computing device is reachable using the first network communication protocol includes: identifying a plurality of devices associated with a user account of the user, wherein the plurality of devices includes the first computing device and the second computing device; and identifying a plurality of communication links between two or more of the plurality of devices.

Example 21. A computing system comprising means for performing any combination of the methods of examples 1-8.

Example 22. A computer-readable storage medium encoded with instructions that, when executed, cause one or more processors to perform any combination of the methods of examples 1-8.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method, comprising:
receiving, by a first application executing at a first computing device and from a second application installed on the first computing device, a request to send data to a second computing device, wherein the first computing device and the second computing device are each associated with a user;
determining, by the first application, whether the second computing device is reachable using a first network communication protocol;
in response to determining that the second computing device is reachable using the first network communication protocol, transmitting, by the first computing device, the data to the second computing device over the first network communication protocol; and
in response to determining that the second computing device is not reachable using the first network communication protocol, transmitting, by the first computing device, the data to the second computing device over a second network communication protocol.

2. The method of claim 1, wherein the first network communication protocol is a short-range wireless network communication protocol that directly communicatively couples the first computing device and the second computing device, and wherein the second network communication protocol is a network protocol that communicatively couples the first computing device and the second computing device via at least one intermediate device.

3. The method of claim 1, further comprising:
identifying a plurality of communication protocols available to the first computing device for transmitting the data to the second computing device; and
selecting the second network communication protocol of the plurality of communication protocols based on a plurality of connectivity heuristics each respectively associated with one or more of the plurality of communication protocols available to the first computing device.

4. The method of claim 3, wherein the plurality of connectivity heuristics includes rules used to select from among the plurality of communication protocols available to the first computing device based on one or more of:
communication protocol range,
signal strength,
type of data to be transmitted, and
user account information.

5. The method of claim 1, wherein a separate instance of the first application is installed on the second computing device, and wherein the user is authenticated on each instance of the first application.

6. The method of claim 5, wherein transmitting the data to the second computing device over the second network communication protocol includes transmitting the data to a server associated with the first application.

7. The method of claim 1, further comprising:
establishing, by the first computing device, a direct communication link with the second computing device in accordance with either the first network communication protocol or the second network communication protocol.

8. The method of claim 1, wherein determining whether the second computing device is reachable using the first network communication protocol includes:
identifying a plurality of devices associated with a user account of the user, wherein the plurality of devices includes the first computing device and the second computing device; and
identifying a plurality of communication links between two or more of the plurality of devices.

9. A system, comprising:
one or more processors; and
a non-transitory computer-readable medium comprising instructions stored therein, which when executed by the one or more processors, cause the one or more processors to perform operations comprising:
receiving, by a first application executing at a first computing device and from a second application installed on the first computing device, a request to send data to a second computing device, wherein the first computing device and the second computing device are each associated with a user;
determining, by the first application, whether the second computing device is reachable using a first network communication protocol;
in response to determining that the second computing device is reachable using the first network communication protocol, transmitting, by the first computing device, the data to the second computing device over the first network communication protocol; and
in response to determining that the second computing device is not reachable using the first network communication protocol:
transmitting, by the first computing device, the data to the second computing device over a second network communication protocol.

10. The system of claim 9, wherein the first network communication protocol is a short-range wireless network communication protocol that directly communicatively couples the first computing device and the second computing device, and wherein the second network communication protocol is a network protocol that communicatively couples the first computing device and the second computing device via at least one intermediate device.

11. The system of claim 9, the operations further comprising:
identifying a plurality of communication protocols available to the first computing device for transmitting the data to the second computing device; and
selecting the second network communication protocol of the plurality of communication protocols based on a plurality of connectivity heuristics each respectively associated with one or more of the plurality of communication protocols available to the first computing device.

12. The system of claim 11, wherein the plurality of connectivity heuristics includes rules used to select from among the plurality of communication protocols available to the first computing device based on one or more of:
communication protocol range,
signal strength,
type of data to be transmitted, and
user account information.

13. The system of claim 9, wherein a separate instance of the first application is installed on the second computing device, and wherein the user is authenticated on each instance of the first application.

14. The system of claim 13, wherein transmitting the data to the second computing device over the second network communication protocol includes transmitting the data to a server associated with the first application.

15. The system of claim 9, the operations further comprising:
establishing, by the first computing device, a direct communication link with the second computing device in accordance with either the first network communication protocol or the second network communication protocol.

16. The system of claim 9, wherein determining whether the second computing device is reachable using the first network communication protocol includes:
identifying a plurality of devices associated with a user account of the user, wherein the plurality of devices includes the first computing device and the second computing device; and
identifying a plurality of communication links between two or more of the plurality of devices.

17. A non-transitory machine-readable medium comprising instructions stored therein, which, when executed by a one or more processors of a first computing device, cause the one or more processors to:
execute a first application;
receive, via the first application and from a second application installed on the first computing device, a request to send data to a second computing device, wherein the first computing device and the second computing device are each associated with a user;
determine whether the second computing device is reachable using a first network communication protocol;
in response to determining that the second computing device is reachable using the first network communication protocol, send the data to the second computing device over the first network communication protocol; and
in response to determining that the second computing device is not reachable using the first network communication protocol, send the data to the second computing device over a second network communication protocol.

18. The non-transitory machine-readable medium of claim 17, wherein the instructions further cause the one or more processors to:
identify a plurality of communication protocols available to the first computing device for transmitting the data to the second computing device; and
select, based on a plurality of connectivity heuristics each respectively associated with one or more of the plurality of communication protocols available to the first computing device, the second network communication protocol of the plurality of communication protocols.

19. The non-transitory machine-readable medium of claim 17, wherein the instructions further cause the one or more processors to:
establish direct communication link with the second computing device in accordance with either the first network communication protocol or the second network communication protocol.

20. The non-transitory machine-readable medium of claim 17, wherein the instructions that cause the one or more processors to determine whether the second computing device is reachable using the first network communication protocol cause the one or more processors to:
identify a plurality of devices associated with a user account of the user, wherein the plurality of devices includes the first computing device and the second computing device; and
identify a plurality of communication links between two or more devices from the plurality of devices.
